(19) United States
(12) Patent Application Publication
(10) Pub. No.: US 2015/0108072 A1
(43) Pub. Date: Apr. 23, 2015

(54) METHOD FOR SEALING A FILTER CHAMBER AND FILTER DEVICE

(71) Applicant: Bernd Böhnke, Eschweiler (DE)

(72) Inventor: Bernd Böhnke, Eschweiler (DE)

(73) Assignee: OUTOTEC (FINLAND) OY, Espoo (FI)

(21) Appl. No.: 14/394,493

(22) PCT Filed: Apr. 19, 2012
(86) PCT No.: PCT/EP2012/057178

§ 371 Date: Oct. 15, 2014

(51) Int. Cl. B01D 35/30; B01D 29/66; B01D 37/00

(52) U.S. Cl. CPC B01D 35/30; B01D 37/00; B01D 29/66
USPC 210/797; 210/767; 210/808; 210/541; 210/409

(57) ABSTRACT

The invention relates to a method for sealing a filter chamber of a filter device, comprising a sequence of steps, including moving the recess plate close to the adjacent recess plate for building the pack, and securing the recess plate to the adjacent recess plate, piping a suspension into the filter chamber on a cake side of a filter cloth, letting a solid content of the suspension settle on the filter cloth as a filter cake, and a liquid fraction of the suspension permeate the filter cloth to a filtrate side thereof, and discharging the filtrate out of the filter chamber. The invention further relates to a recess plate for use in a filter device, the recess plate comprising a recess, and a groove encircling the recess, the groove being adapted to receive a sealing ring for sealing a filter chamber.

### TECHNICAL FIELD

The invention relates in general to filtering and in particular to a method for sealing a filter chamber of a filter device, to such filter device and to a recess plate.

### BACKGROUND ART

In press filter devices and the like, a filter chamber is formed between two adjacent recess plates by the recess of at least one of the recess plates. In order to seal the filter chamber, at least one of the adjacent recess plates is provided with a sealing ring that encircles and seals the filter chamber when the recess plates are pressed together. In normal operation of press filter devices, leakage of the sealing delivers small amounts of suspension into a gap formed between the adjacent recess plates. The solid contents of the suspension settles between the recess plates and builds a cake, that, during the following filtration cycle, increases the leakage and the delivery of suspension into the gap. The build-up of a filter cake between the recess plates outside of the filter chamber requires thorough examination and cleaning of soiled surfaces between filtration cycles. Failure to meet this requirement potentially leads to serious malfunction of filter devices, pollution of the ambience of filter devices and substantial downtime for cleaning and maintenance.

### PROBLEM TO BE SOLVED

Thus it is an object of the invention to reduce delivery of suspension into the gap between the recess plates.

### SUMMARY OF INVENTION

The invention suggests a method for sealing a filter chamber of a filter device, the filter device having a pack of at least a (first) recess plate and an adjacent recess plat; the recess plate having a first recess and/or the adjacent recess plate having a second recess, the first recess and/or the second recess forming the filter chamber between the recess plate and the adjacent recess plate, the recess plate having a groove encircling the filter chamber, and a sealing ring inserted into the groove, the sealing ring sealing the filter chamber from a gap between the recess plate and the adjacent recess plate, the method comprising a sequence of steps, including moving the recess plate close to the adjacent recess plate for building the pack, and securing the recess plate to the adjacent recess plate, piping a suspension into the filter chamber on a cake side of a filter cloth, letting a solid content of the suspension settle on the filter cloth as a filter cake, and a liquid fraction of the suspension permeate the filter cloth to a filtrate side thereof, and discharging the filtrate out of the filter chamber, and to move the recess plate and the adjacent recess plates into contact, and then to force the sealing ring out of the groove towards the adjacent recess plate. Moving into contact reduces the gap between the recess plates to the minimum possible, i.e. to the thickness of the filter cloths between the recess plates. The potential for building a cake inside the gap is thus minimized, even without further sealing. Securely moving the recess plates into contact requires to overcome the opposing force that results from squeezing the sealing ring—or to avoid such squeezing.

Squeezing is avoided if, instead of protruding from the surface of the recess plate, the sealing ring is hidden inside the groove. After the recess plates being in contact and secured in this position, forcing the sealing ring out of the groove activates the sealing function of the sealing ring.

In a filter device, used for executing a method according to the invention the filter chamber has a movable membrane, the membrane and the recess plate enclosing a squeezing chamber, the recess plate having an inlet duct for inserting a squeezing fluid into the squeezing chamber, for mechanical pressing out of the respective filter cake, and the sealing ring forming an edge of the membrane. In such filter device, the sealing ring has the further function to keep the flexible membrane in the required shape and position.

Preferably, within a method according to the invention, the sealing ring is flared while forced out of the groove. The sealing ring may either be U-shaped, having two sealing lips at either walls of the groove, and a recess between the lips, or have a tubular shape, substantially filling the groove. Flaring the sealing ring boosts the sealing effect against the groove.

Further preferred, within a method according to the invention, a forcing fluid forces the sealing ring out of the groove. A forcing fluid provides equal pressure—and thus sealing force—throughout the sealing ring. However, a forcing fluid requires respective ducts, and maintenance and sealing of the same. Alternatively, the sealing ring is mechanically forced out of the groove, in particular by a solenoid pushing a metal ring underneath the sealing ring out of the groove. Further alternatively, the sealing ring itself may be equipped with metal parts and pushed out of the groove by solenoids.

In such method according to an embodiment of the invention, the forcing fluid preferably is pressurized air. Pressurized air is usually available or may easily be provided in industrial plants. However, providing high pressure starting from ambient pressure requires feeding considerable amount of pressurized air into the respective pressure chambers. Alternatively, the forcing fluid is a liquid, in particular water or hydraulic oil, or the process liquid itself, to avoid contamination in case of leakage (e.g. palm oil). A recess plate in a filter device, used for executing such method preferably has a separate forcing system, that remains filled with the liquid, and is externally provided with the pressure for forcing the sealing ring out of the groove.

In an advantageous embodiment of the invention, the forcing fluid is pressurized to at least a maximum pressure present inside the filter chamber, during a filtration cycle, and at the utmost to 1.5 times the maximum pressure. Maintaining the pressure in this range, equally provides secure sealing, and avoids damaging the recess plates.

Preferably, within a method according to the invention, pressure of the forcing fluid is kept substantially constant until re-opening of the pack. Keeping the pressure constant renders managing the pressure simple.

In a further advantageous embodiment of the invention, the recess plate is hydraulically pressed to the adjacent recess plate until re-opening of the pack. Securing the position of the recess plates may—as is commonly known—be achieved by applying an external force (e.g. hydraulic pressure) to the pack or by mechanical means (e.g. a knee lever).

The invention further suggests a recess plate for use in a filter device, the recess plate comprising a recess, and a groove encircling the recess, the groove being adapted to receive a sealing ring for sealing a filter chamber formed by the recess between the recess plate and an adjacent plate from a gap formed between said plates outside the filter chamber, and to provide a fluid duct adapted to communicate with a fluid channel extending from a head piece of the filter device to the recess plate, and to feed a forcing fluid into the groove.

Further according to an embodiment of the invention, a movable membrane is provided, the membrane and the recess plate enclosing a squeezing chamber, the recess plate having an inlet duct for inserting a squeezing fluid into the squeezing chamber, for mechanical pressing out of the respective filter cake, and the sealing ring forming an edge of the membrane.

The invention further suggests a filter device, having between a stationary head piece and a movable end piece a pack of at least a recess plate according to the invention and an adjacent recess plate, the recess of the recess plate and/or a second recess of the adjacent recess plate forming the filter chamber between the recess plate and the adjacent recess plate, into which filter chamber a suspension can be supplied on a cake side of a filter cloth, and the suspension can permeate the filter cloth to a filtrate side thereof, such that a solid content of the suspension settles on the filter cloth as a filter cake. In a filter device according to an embodiment of the invention, the recess plates of the pack are vertically stacked on top of each other or hanging side by side. The filter device is secured by hydraulic force, by the weight of the stacked recess plates and/or by mechanical means. The recess plates are made of plastics, e.g. polypropylene (PP), or of metal, e.g. aluminium or steel. Each filter chamber is equipped with at least one filter cloth, but may be equipped with two filter cloth, where in the first case the suspension is piped into the recess of one adjacent recess plate and permeating the filter cloth to the other, and in the latter case filled in between the filter cloths and permeating to both adjacent recess plates.

Preferably, a filter device according to the invention has a conduit for connecting the fluid duct to a process air reservoir, wherein the process air reservoir is provided for feeding process air into the filter chamber. Such filter device uses a previously existing unit for an additional task, thereby reducing the need for additional units.

Further preferred, a filter device according to the invention has a forcing fluid reservoir providing the forcing fluid at essentially constant pressure into the groove. Such filter device allows for executing the above mentioned preferred method and is equally characterized by the advantages mentioned above.

In an advantageous embodiment a filter according to the invention has a forcing fluid compressor providing the forcing fluid at an adjustable pressure into the groove. By adjusting the pressure of the forcing fluid, the filter device can be accommodated to different needs.

Further according to an embodiment of the invention, a group of above filter devices is suggested, the group having a conduit, connecting the fluid ducts of the filter devices. The filter devices of the group according to the invention may be provided with the forcing fluid by one single supply unit, in particular one process air reservoir, forcing fluid reservoir and/or forcing fluid compressor.

### BEST MODE FOR CARRYING OUT THE INVENTION

The method according to the invention and the associated device are subsequently described in more detail with reference to preferred embodiments illustrated in the drawing figure.

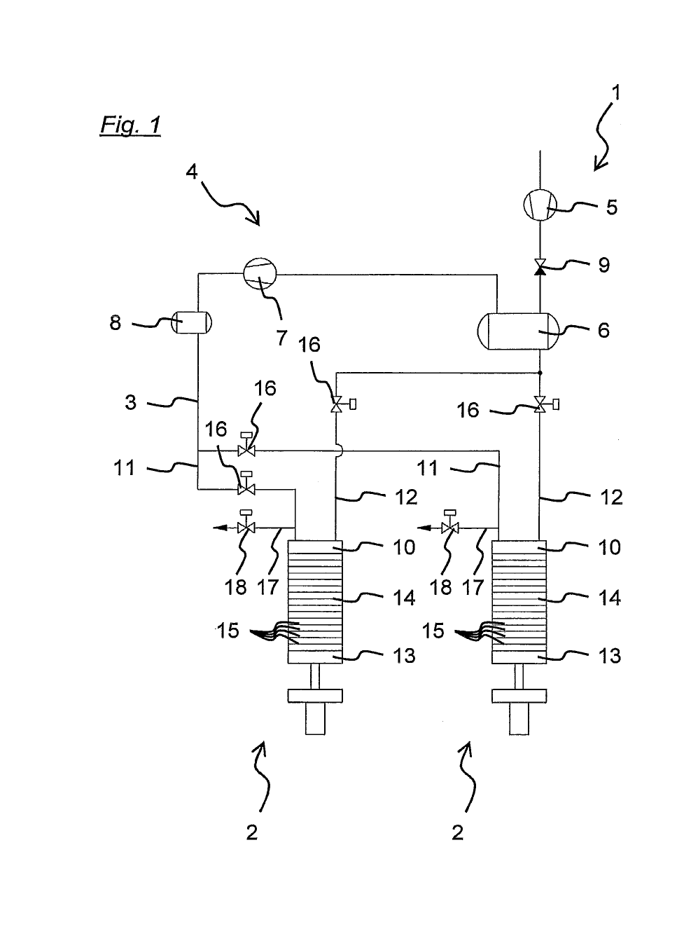

FIG. 1 shows a schematic view of a group of filter devices according to the invention,

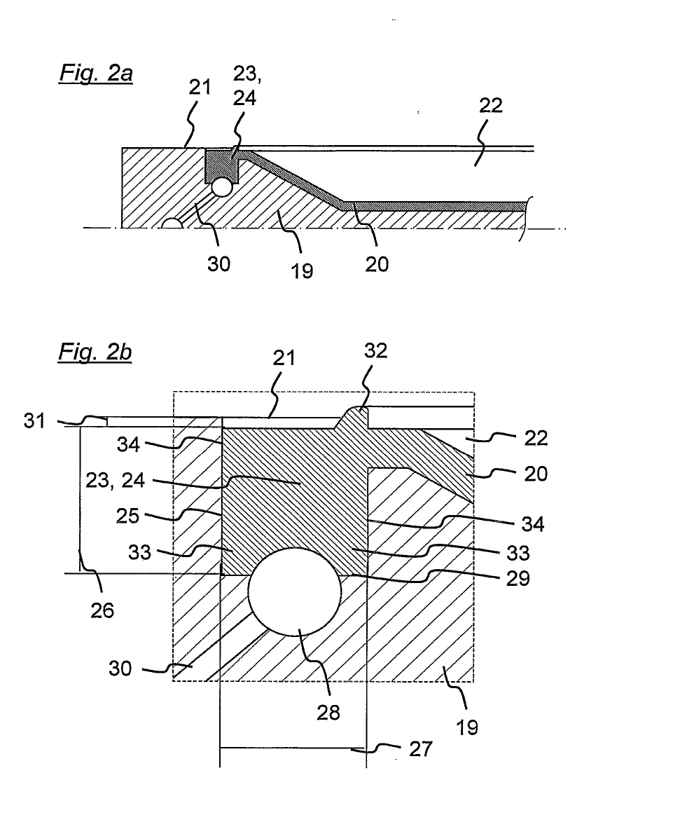

FIG. 2a/b shows a detail of a filter device according to the invention, and

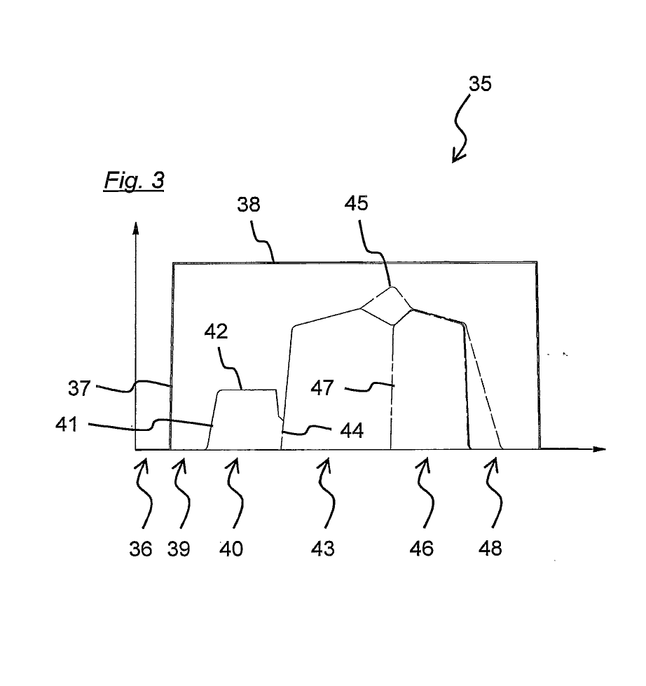

FIG. 3 shows a pressure profile of a filtration cycle, including a method according to the invention

The group 1 of two filter devices 2, shown in FIG. 1, both the group 1 and the filter devices 2 according to the invention, has a conduit 3, providing the filter devices 2 with one common supply unit 4 for a forcing fluid (here: compressed air at 30 bar), the supply unit 4 having a process air compressor 5, a process air reservoir 6, a forcing fluid compressor 7 and a forcing fluid reservoir 8. The process air compressor 5 takes ambient air from the ambience of the group 1, for filling the process air reservoir 6. A check valve 9 prevents the process air from discharging back through the process air compressor 5.

At a respective stationary head piece 10, each filter device 2 has a fluid duct 11 connected with the conduit 3, and an air duct 12 connected with the process air reservoir 6. Between the head piece 10 and a movable end piece 13, the filter devices 2 each have a pack 14 of a total of 70 recess plates 15. The fluid ducts 11 and the air ducts 12 each have a gate valve 16 for opening and closing the respective ducts. Each filter device 2 further has a fluid outlet 17 connected to the respective fluid duct 11, provided with further outlet valves 18 for discharging process air, including the forcing fluid, to the ambience.

The recess plate 15, exemplarily in detail shown in FIGS. 2a and 2b, has a base body 19 made of PP, measuring 3000×3000×100 mm width×height×thickness, and a movable membrane 20, made of rubber. On a first face 21, the recess plate 15 has a first recess 22, and on a second face opposite to the first face 21 the recess plate 15 has a second recess. The second face and the second recess are not shown in the detail view of FIGS. 2a and 2b. In the pack 14, between two adjacent recess plates 15, the first recess 22 of a recess plate 15 and the second recess of an adjacent recess plate 15 form a filter chamber.

The membrane 20 has an outer edge 23 that is designed to be a sealing ring 24 between the recess plates 15 and the adjacent recess plates 15, sealing the filter chamber from a gap between the recess plates 15 and the adjacent recess plates 15, and preventing any content of the filter chamber from being emitted through the gap to the ambience.

The recess plate 15 has a groove 25, encircling the filter chamber, and taking the sealing ring 24. The groove 25 has a rectangular profile with depth 26 of 15 mm and width 27 of 10 mm and a circular distribution channel 28, running on the ground 29 of the groove 25. The recess plate 15 further has a fluid duct 30, connecting the distribution channel 28 to a through hole (not shown) of the recess plate 15, in the pack 14 these through holes of all recess plates 15 forming a fluid channel, connecting to the fluid duct 11 of the head piece 10.

The sealing ring 24 has a rectangular profile with width matching the width, but leaving unfilled a height 31 of 3 mm of the groove 25. The sealing ring 24 further has a sealing lip 32, protruding 1 mm from the groove 25. The sealing ring 24 is U-shaped, having sealing lips 33 at either wall 34 of the groove 25.

The recess plates 15 of the pack 14 and the end piece 13 are guided at check rails of the respective filter device 2, and opened to a distance of 100 mm between adjacent recess plates 15, for cleaning and revision of the filter device 2. The pressure profile of new filtration cycle 35 is shown in FIG. 3: Starting the filtration cycle 35, during a closing period 36 the end piece 13 is moved towards the head piece 10 by hydraulic rams, until all recess plates 15 are loosely in contact. In this position, the end piece 13 is pressed to the pack.

After the closing period 36, the fluid channel of the pack 14 and the distribution channels 28 of each recess plate 15 are filled with the forcing fluid at a forcing fluid pressure 37 up to a maximum forcing pressure 38 of 20 bar, i.e. about 1.5 times the maximum expected process pressure. The forcing fluid forces the sealing rings 24 out the grooves 25 and thus seals the filter chambers from the remaining gaps between the adjacent recess plates 15. The forcing fluid further flares the sealing ring 24 by forcing the sealing lips 33 towards the walls 34 of each groove 25, thus boosting the sealing effect of the sealing ring 24.

During a filling period 39, the filter chambers are filled with the suspension. This completed, the filtration period 40 starts by pressing the suspension through the filter cloths. While the solid content of the suspension settles at the filter cloths, and the liquid fraction of the suspension permeates the same and is discharged from the filter chambers, the suspension pressure 41 rises up to a maximum suspension pressure 42 of 9 bar, and remains at this value while the suspension flow decreases.

At a step change over condition, the filter device 2 is disconnected from the suspension supply and a squeezing period 43 starts by charging the membranes 20 with a squeezing fluid, namely water, at a squeezing pressure 44. The membranes 20 are forced into the filter chambers by the squeezing fluid, and squeezing the remaining suspension out of the filter cake.

The squeezing pressure 44 reaching the maximum squeezing pressure 45 of 16 bar, a drying period 46 starts by supplying the filter chamber with the process air at a process air pressure 47 from one recess plate 15 and discharging the same through the filter cloths and the filter cake inbetween, and into the other recess plate 15.

At a further step change over condition, in a releasing period 48 the filter device 2 is disconnected from the process air reservoir 6, and subsequently from the sealing fluid reservoir. Finally, the end plate is released and the filter device 2 and the pack 14 of recess plates 15 opened for unloading the filter cake, for cleaning and revising the filter cloths, the membranes 20 and the recess plates 15, in particular the filter chambers, for another filtration cycle 35.

### IN THE FIGURES

1 group
2 filter device
3 conduit
4 supply unit
5 process air compressor
6 process air reservoir
7 forcing fluid compressor
8 forcing fluid reservoir
9 check valve
10 head piece
11 fluid duct
12 air duct
13 end piece
14 pack
15 recess plate
16 globe valve
17 fluid outlet
18 outlet valve
19 base body
20 membrane
21 first face
22 first recess
23 edge
24 sealing ring
25 groove
26 depth
27 width
28 distribution channel
29 ground
30 fluid duct
31 height
32 sealing lip
33 sealing lip
34 wall
35 filtration cycle
36 closing period
37 forcing fluid pressure
38 maximum forcing pressure
39 filling period
40 filtration period
41 suspension pressure
42 maximum suspension pressure
43 squeezing period
44 squeezing pressure
45 maximum squeezing pressure
46 drying period
47 process air pressure

1. Method for sealing a filter chamber of a filter device, the filter device having a pack of at least a recess plate and an adjacent recess plate, the recess plate having a first recess and/or the adjacent recess plate having a second recess, the first recess and/or the second recess forming the filter chamber between the recess plate and the adjacent recess plate, the recess plate having a groove encircling the filter chamber, and a sealing ring inserted into the groove, the sealing ring sealing the filter chamber from a gap between the recess plate and the adjacent recess plate, the method comprising a sequence of steps, including
a. moving the recess plate and the adjacent recess plate close together for building the pack,
b. securing the recess plate to the adjacent recess plate,
c. piping a suspension into the filter chamber on a cake side of a filter cloth,
d. letting a solid content of the suspension settle on the filter cloth as a filter cake, and a liquid fraction of the suspension permeate the filter cloth to a filtrate side thereof, and
e. discharging the filtrate out of the filter chamber,
characterized by moving the and adjacent recess plates into contact, and then forcing the sealing ring out of the groove towards the adjacent recess plate.

2. Method according to claim 1, further characterized by the filter chamber having a movable membrane, the membrane and the recess plate enclosing a squeezing chamber, the recess plate having an inlet duct for inserting a squeezing fluid into the squeezing chamber, for mechanical pressing out of the respective filter cake, and the sealing ring forming an edge of the membrane.

3. Method according to claim 1, further characterized by the step of flaring the sealing ring while forcing out of the groove.

4. Method according to claim 1 further characterized by a forcing fluid forcing the sealing ring out of the groove.

5. Method according to claim 4, further characterized by the forcing fluid being pressurized air.

6. Method according to claim 5, further characterized by pressurizing the forcing fluid to at least a maximum pressure inside the filter chamber, during a filtration cycle, and at the utmost to 1.5 times the maximum pressure inside the filter chamber.

7. Method according to claim 6, further characterized by keeping a pressure of the forcing fluid substantially constant until re-opening of the pack.

8. Method according to claim 7 further characterized by hydraulically pressing the recess plate to the adjacent recess plate until reopening of the pack.

9. Recess plate for use in a filter device, the recess plate comprising
a. a recess, and
b. a groove encircling the recess, the groove being adapted to receive a sealing ring for sealing a filter chamber formed by the recess between the recess plate and an adjacent plate from a gap formed between said plates outside the filter chamber,
characterized by a fluid duct adapted to communicate with a fluid channel extending from a head piece of the filter device to the recess plate, and to feed a forcing fluid into the groove.

10. Recess plate according to claim 9, further characterized by a movable membrane, the membrane and the recess plate enclosing a squeezing chamber, the recess plate having an inlet duct for inserting a squeezing fluid into the squeezing chamber, for mechanical pressing out of the respective filter cake, and the sealing ring forming an edge of the membrane.

11. Filter device, having between a stationary head piece and a movable end piece a pack of at least a recess plate according to claim 10, wherein an adjacent recess plate, the recess of the recess plate and/or a second recess of the adjacent recess plate forming the filter chamber between the recess plate and the adjacent recess plate, into which filter chamber a suspension can be supplied on a cake side of a filter cloth, and the suspension can permeate the filter cloth to a filtrate side thereof, such that a solid content of the suspension settles on the filter cloth as a filter cake.

12. Filter device according to claim 11 characterized by a conduit for connecting the fluid duct to a process air reservoir, wherein the process air reservoir is provided for feeding process air into the filter chamber.

13. Filter device according to claim 12, characterized by a forcing fluid reservoir providing the forcing fluid at essentially constant pressure into the groove.

14. Filter device according to claim 13, characterized by a forcing fluid compressor providing the forcing fluid at an adjustable pressure into the groove.

15. Group of filter devices according to claim 14, characterized by a conduit, connecting the fluid ducts of the filter devices.
